(19) United States
(12) Patent Application Publication
(10) Pub. No.: US 2005/0230061 A1
(43) Pub. Date: Oct. 20, 2005

(54) Combined window blind and security shutter

(76) Inventor: Brian Malcolm Wilkins, Nottinghamshire (GB)

Correspondence Address: MAINE & ASMUS, 100 MAIN STREET, P O BOX 3445, NASHUA, NH, 03061-3445, US

(21) Appl. No.: 11/167,701

(22) Filed: Jun. 27, 2005

Related U.S. Application Data
(63) Continuation of application No. 10/333,539, filed on Jan. 21, 2003.

(30) Foreign Application Priority Data
Jan. 30, 2001 (GB) 0102315.9
Jul. 18, 2000 (GB) 0017462.3

(51) Int. Cl. E06B 9/36

(52) U.S. Cl. 160/172 R

(57) ABSTRACT

A combined window blind and security shutter comprising; a support structure (51) securable in a window opening (54); a plurality of rigid blades (50) extending across the support structure, each blade having therein a rigid reinforcing member (56) having at each end thereof a spindle engaged in the support structure in such a manner as to maintain a parallel relationship between the blades whilst permitting rotation of the blade about the spindles; and control mechanism (e.g., such as a motorized pull cord) for simultaneously rotating the blades between a closed position, in which the blades lie substantially parallel to the window so as to form together a continuous shutter therefor, and an open position, in which the blades extend substantially normally to the window to permit light and air to pass therebetween.

This application is a continuation to pending U.S. application Ser. No. 10/333,539, filed Jan. 21, 2003, which claimed priority to International application PCT/GB01/03121 filed 11 Jul. 2001, which claimed priority to GB0102315.9 filed 30 Jan. 2001 and to GB0017462.3 filed 18 Jul. 2000.

### FIELD OF THE INVENTION

This invention relates to window blinds and window security shutters.

### BACKGROUND TO THE INVENTION

Security shutters for windows typically take the form of lockable external hinged shutters or roller shutters. While these are very effective in preventing unauthorised access through a window, i.e. preventing burglary, they are often unattractive, expensive to install, and are generally only usable when the building is unoccupied, since they form a complete barrier across the window. An alternative approach is to use security grilles. These are often used in commercial premises, and can be installed inside the window, being slid aside when not required. While these are preferable to external shutters in not being as obvious a sign that the building is unoccupied, they have disadvantages as well; for example, they can engender a “prison cell” feeling if used while the building is occupied, they can be unattractive to look at, and they do not serve any shading function, nor contribute to thermal insulation.

Various types of blind are known for use with windows, for example the vertical strip blind, which comprises a plurality of vertical fabric or other flexible strips suspended from a track along the top of the window. The strips are rotatable so as to overlap to form a continuous closed surface or to extend normally to the window to allow light and air through. When not required, the strips can be slid to one side of the window opening. Such vertical blinds are widely used, especially in offices, but they do not contribute to security against break-in, other than to prevent, when closed, the contents of the room being seen from outside. In addition, they generally provide a lower level of thermal insulation than conventional curtains.

UK Patent Application No GB2312230 describes a security screen with blades that are rotatably mounted within a support structure but which require physical removal to gain access to the window.

### SUMMARY OF THE INVENTION

According to the invention, there is provided a combined window blind and security shutter, comprising a support structure comprising two parallel tracks securable on opposing sides of a window opening, a plurality of rigid blades extending across the support structure, each blade having therein a rigid reinforcing member having at each end thereof a spindle engaged in a respective one of the two parallel tracks in such a manner as to maintain a parallel relationship between the blades whilst permitting rotation of the blade about the spindles, control means for simultaneously rotating the blades between a closed position, in which the blades lie substantially parallel to the window so as to form together a continuous shutter therefor, and an open position, in which the blades extend substantially normally to the window to permit light and air to pass therebetween, locking means operable to constrain the spindles from lateral movement along the tracks while still permitting rotation thereof, the locking means being selectively releasable to allow lateral movement of the spindles, and means for drawing a first portion of the spindles to one side of the window opening and a second portion of the spindles to the opposite side of the window opening.

It will be appreciated that sliding of the blades or, alternatively, opening of a mounting frame, will be necessary for reasons of safety, to permit escape from the building through the window in the event of an emergency, any maintenance, to permit cleaning of the inner surface of the window, for example.

Although reference is made throughout to “windows”, it will be understood that the invention is applicable to glazed doors and the like.

Preferably, the blades are formed of a plastics material having low thermal conductivity so as to form an insulating barrier when closed together, thereby reducing heat losses through the window. Advantageously a plastics material may be further reinforced by the incorporation of a strengthening material such as Kevlar. Alternatively, the blades may be formed from a strong lightweight material such as aluminium or the like. These materials may be suitably formed into shape by extrusion, with any internal spacing being filled with expanded plastics material to supplement the insulating properties of the blade.

The blades may also be formed with at least one reflective surface, which can be presented to the exterior to reduce absorption of radiant energy from the sun in hot weather conditions, or to the interior to reflect back thermal radiation in the room, thereby reducing further heat losses in cold conditions.

It may also be beneficial for the blades to have means for receiving an aesthetic finishing strip, for example to co-ordinate the blinds with a particular decorative style. Another use may be to use the receiving means to attach a pictorial or written message, which can be presented when the blades are in their closed position.

The control means for rotating the blades may comprise, in its simplest form, a cord joining the corresponding edges of the set of blades together so that pulling the cord in one direction rotates the blades simultaneously in that direction and pulling the cord in the opposite direction reverses the rotation of the blades. It is preferred to provide a pair of such cords, running along opposite side edges of the blades. The cords may then be connected together through a reversible hand- or motor-operated crank to open or close the blades. It will be seen that a single cord may be substituted for a joined pair of cords.

The spindles may be joined together by other cords or similar flexible members, coupled at predetermined intervals to the spindles so as to regulate their spacing one from another and to permit the spindles, when released by the spindle locking means, to be slid along the track and collected together at one end thereof, giving free access to the window, for example for cleaning purposes. The sliding of the blades in each direction may be achieved by a pulley. An alternative arrangement provides a separate cord loop connected only to the end spindle, with means to pull the loop in the two directions, either to slide the blades to their spaced positions across the window or to gather them.

It is appreciated that the application of the above system is adapted to collect the blades into two groups, one at either side of the support structure, as is the case with standard curtains. In this way a balanced appearance may be achieved when the blades are retracted.

The cord loop may be driven by a manually operated pulley, or by a motor-driven pulley.

In order to facilitate the lateral movement of the blades along the track, each spindle may be rotatably mounted to a carriage arrangement. Preferably each carriage comprises a spindle housing, which allows the rotation of the spindle, wheels, which engage the track and facilitate the movement of the carriage along the track, and a cord connection point, which receives communication from the blade control means whereby the carriage is caused to travel along the track.

It may also be preferable for adjacent carriages to be connected by spacing members, so that when the blades are being moved to their spaced position, i.e. covering the window opening, the movement of each carriage is limited by its neighbouring carriage. In this way by fixing the movement of an end carriage, the rest of the carriages can be made to locate their associated blades at the correct position within the support structure every time.

The track conveniently comprises an elongate hollow member, of square cross-section, with a slot opening into it along the length thereof, the spindles being shaped so as to extend through the slot and to have a head portion which is trapped within the slot. Preferably the track will comprise a path arrangement, for the carriages to travel along, and a housing for the spindle locking means.

The spindle locking means may comprise an elongate rigid member, having receiving means positioned periodically along the length thereof, wherein the receiving means are engageable to the corresponding spindles of each blade, thereby constraining the spindles from lateral movement within the support structure. Although, the elongate rigid member may be engaged by a sliding mechanism it is appreciated that it may be engaged by a pivoted mechanism.

For added security, a dead locking system may be incorporated into the spindle locking means. The dead lock could be activated manually or alternatively it could be triggered by the engagement of the elongate rigid member with the spindles. It will be appreciated that a dead lock may be achieved in number of ways. One preferred style of dead lock involves a two-part device comprising two members with complementary ridging thereon. When in the unlocked position the two members sit complementary to one another with the troughs on one member accepting the ridges on the other. However, when in the locked position the members are forced out of this complementary state and by a camming mechanism the dimensions of the device are increased. The dead locking device may be positioned relative to the elongate rigid member so that the change in the dead locks dimensions blocks the return of the elongate rigid member to its unengaged position.

Alternatively, the locking means may comprise a tube located within the hollow member and provided with a longitudinal slot which can be aligned with the slot in the hollow member and which is provided with a set of locking slots spaced at predetermined intervals along the tube and extending circumferentially for a short distance. The tube is arranged to be rotatable within the hollow member when the blades are in their correct spaced relationship along the tracks so that the spindles are received in the locking slots and constrained from movement along the tracks. A key-operated lock may be provided to prevent rotation of the tube from the locking position. The lock may comprise a locking screw which extends into a hole in the circumference of the tube, and the key may be a specially-shaped tool to rotate the screw, for example in a manner conventional in window locks and the like.

The hollow member may be made from a material, such as nylon, that is self lubricating, thus allowing easy movement of the tube within the said member. Alternatively the hollow member may be made from metal, for example an extruded aluminium section, with a self-lubricating insert, for example of nylon, having a semi-circular channel to receive and support the tube for rotation relative thereto. The hollow member may be formed from two or more parts which can be separated to facilitate the introduction of the said tube.

The metal members in the blades may be steel bars, which can be dimensioned and hardened or otherwise treated to render the bars resistant to attack by an intruder seeking to force his way through the window.

Further reinforcement may be gained by the use of a reinforced metal bar, of suitable dimensions, which can be secured adjacent to the blades across the window opening by lockable means, thereby temporarily preventing rotation of the blades. It may be of further advantage if the bar comprises a ladder arrangement. In this way, anyone trying to cut through the bar will have to cut through two areas of metal before the bar is disabled.

The invention provides a combined window blind and security shutter that may have the appearance of a conventional vertical strip blind, for example, which will be found more acceptable by most users than mesh or bar security grilles or external shutters. The blind has thermal insulating properties, thus providing some of the advantages of curtains or shutters. Opening and closing of the blades, and the sliding aside of the blades for access to the window, can all be carried out by motorised controls, permitting the blind to be operated remotely, or even automatically, for example on a timer, or in response to changes in daylight, thus affording additional security to the building when unoccupied by giving the appearance of occupation. The blind is simple in construction and will be straightforward to install.

### BRIEF DESCRIPTION OF THE DRAWINGS

In the drawings, which illustrate an exemplary embodiment of the invention:

FIG. 1 is a diagram illustrating eight of the blades and the controls sliding them to the extended position, but omitting the tracks;

FIG. 2 is a diagram illustrating eight of the blades and the controls sliding them to the retracted position, but omitting the tracks:

FIG. 3 is sectional view of the track showing the relationship between the blade spindle and the track, with the spindle locking means open;

FIG. 4 shows the embodiment of FIG. 3, with the spindle locking means closed;

FIG. 5 is a diagrammatic plan view of the preferred embodiment of the spindle locking mechanism in its open position;

FIG. 6 is a diagrammatic plan view of the preferred embodiment of the spindle locking mechanism in its engaged position;

FIG. 7 is a diagrammatic representation of the spindle locking mechanism control means;

FIG. 8 is a diagrammatic plan view of the sliding side of the support structure; and

FIG. 9 is a diagrammatic plan view of the locking side of the support structure.

### DETAILED DESCRIPTION OF THE ILLUSTRATED EMBODIMENT

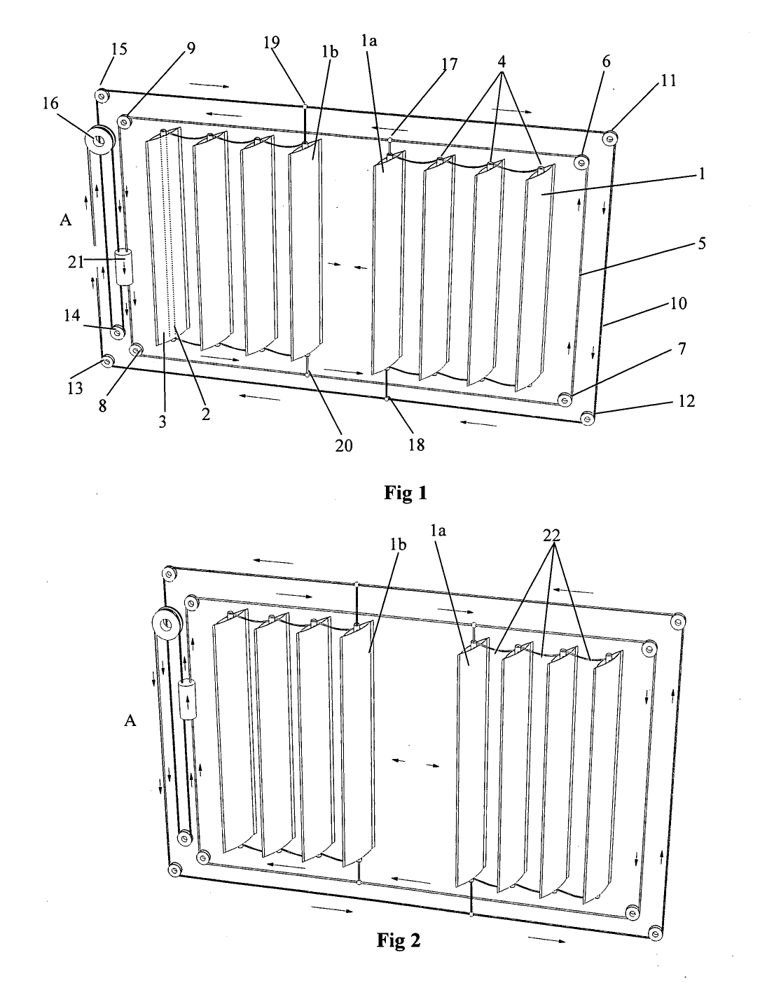

Referring first to FIG. 1, the blind comprises a plurality of generally vertical blades 1, of which eight are shown in this exemplary embodiment. Each blade 1 comprises a steel bar 2 as a core, with a plastics or aluminium body 3 formed around it, as may be seen in the left-most blade of the diagram. The steel bar 2 has a spindle 4 extending from each end thereof, each spindle having a portion that is received in a track, details of which are not shown.

A first control cord 5 is formed in a loop around a first set of pulleys 6 to 9, and is attached to the top spindle of blade 1a via linkage 17 and the bottom spindle of blade 1b via linkage 20. A second cord 10 is formed in a figure of eight loop around a second set of pulleys 11 to 16, and is attached to the bottom spindle of blade 1a via linkage 18 and the top spindle of blade 1b via linkage 19. The first cord 5 and second cord 10 are linked via linkage 21 so that movement of one of the cords causes the movement of the other.

It will be seen that, when cord 10 is moved in an upward direction at point A the pulley arrangement causes the blades 1a and 1b to be drawn together. Inter-blade linkages 22 allow the movement of blades 1a and 1b to be transferred causing the intermediate blades to be moved to their non-retracted position. It is appreciated that alternative pulley arrangements may achieve the same desired effect.

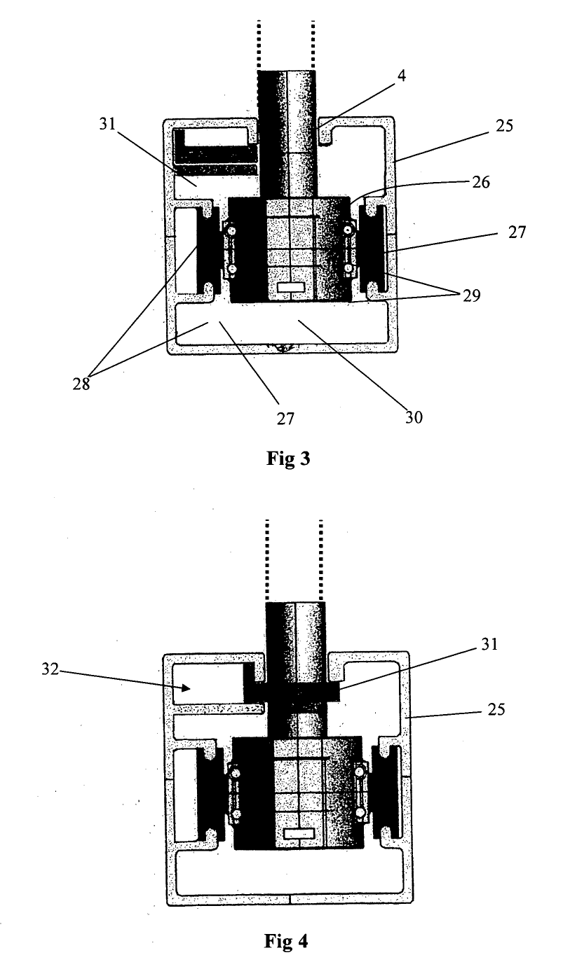

FIG. 2 shows the procedure in reverse with cord 10 being moved downwards at point A. Due to linkages 17 to 20, blades 1a and 1b are moved towards the sides of the support structure. As blades 1a and 1b retract they gather the intermediate blades in their path, whereby all the blades are drawn to the sides of the support structure.

It will be understood that the rotation of the blades may be facilitated by a separate cord and pulley system, which is not shown in the figures.

FIG. 3 shows the preferred arrangement of how the spindle 4 interacts with the track 25. The spindle 4, of which only the end portion is shown, is rotatably mounted within the carriage 26. The track 25 has races 28 along which the carriage wheels 27 may travel. The carriage also has receiving means 30, which interact with spacing members (not shown) to facilitate the correct spacing between the blades 1 when they are moved into the non-retracted position. A cord may be passed through apertures 29, thereby forming linkages 17 to 20 such as the ones shown in FIGS. 1 and 2.

When the blades are evenly spaced apart across the window opening their lateral movement can be prevented by a spindle locking means. In the preferred embodiment the spindle locking means is provided by an elongate rigid member 31. The rigid member comprises a set of receiving slots arranged periodically along its length. These slots engage the spindles 4 and thereby lock them in position, this mechanism is more clearly defined hereafter.

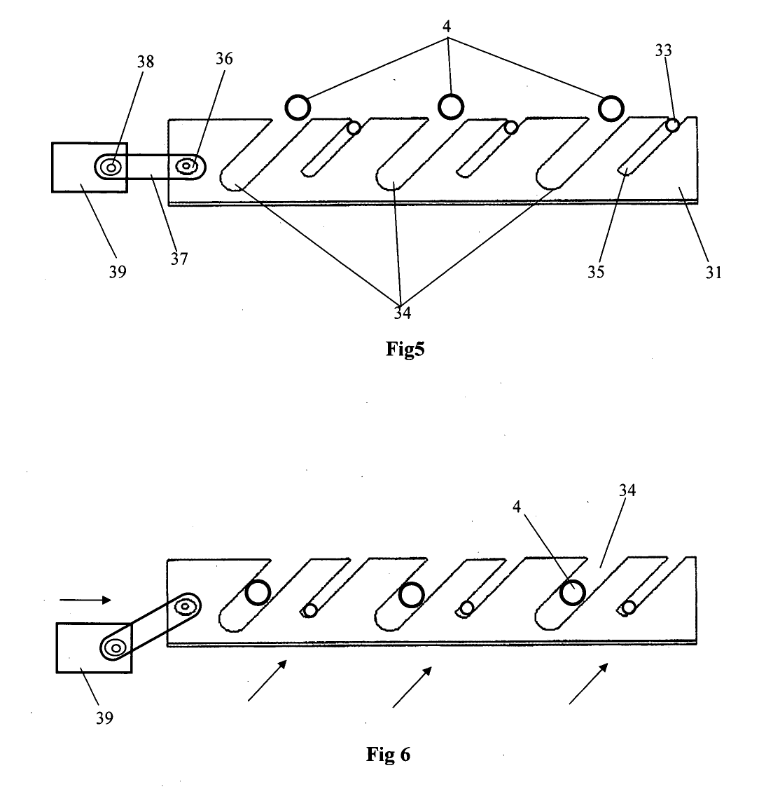

It can be seen from FIG. 4 how the elongate rigid member 31 moves across to engage the spindle 4. As a result of this movement a cavity 32 is created. It is appreciated that a dead locking mechanism (not shown) may be arranged to partially fill the cavity 32 and thereby prevent the elongate rigid member 31 from returning to its open position. It is appreciated that this dead lock mechanism could be manually actuated or alternatively it could be actuated by the same drive means that move the elongate rigid member 31 from its open position to its engaged position.

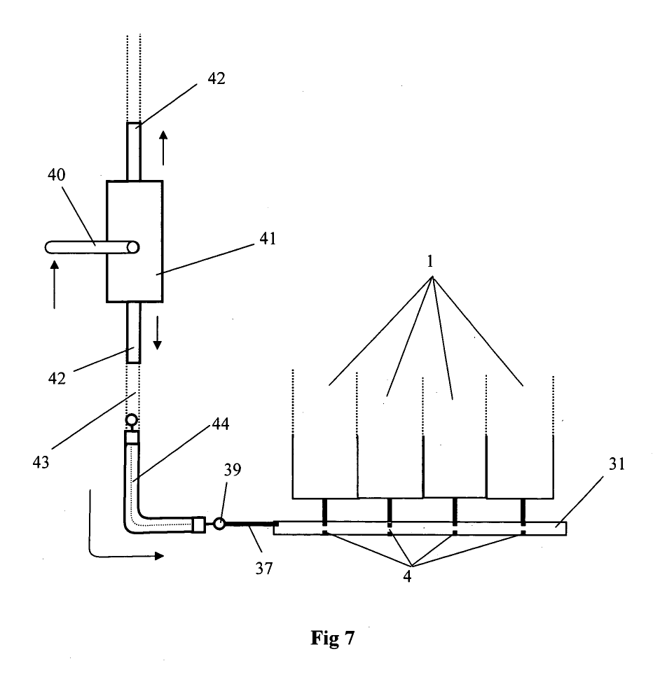

FIG. 5 shows a preferred embodiment of the spindle locking mechanism in its open position. The elongate rigid member 31 has a plurality of slots cut along its length. The slots are arranged at an angle of less than 90°, preferably between 60° and 30° to the length of the member 31. There are two types of slot; firstly the spindle receiving slots 34, which are of dimensions which are suitable to engage the corresponding spindle. The second type of slot is the guiding slot 35; these slots constantly engage guiding rods 33, which may preferably be located on the track.

Also attached to the elongate rigid member 31 is a drive shaft 37, which is attached by a first pivot joint 36. The opposite end of the drive shaft 37 is connected to a drive means 39 by a second pivot 38. When the drive means 39 is actuated the spindle receiving slots 34 engage the spindles 4 thus restricting their lateral movement. The pivoted relationship between the elongate rigid member 31 and the drive means 39 facilitates the angular path of the elongate rigid member 31.

FIG. 6 shows the arrangement of FIG. 5, when the spindles 4 are engaged by the receiving slots 34.

The mechanism for controlling the actuation of the spindle locking means can be understood from FIG. 7. The handle 40 is arranged to work a standard cog arrangement, which is held within housing 41. Upon working of the handle (as shown by the upward arrow) the cog arrangement causes bolts 42 to extend from the housing 41 in the directions shown. The movement of the bolts 42 is transferred through a conduit 43 in the support structure by means not shown. Although the movement may preferably be transferred by a rigid member it is appreciated that other mechanisms, such as hydraulics may be used.

In order to transfer the vertical movement around a corner in the support structure a ‘tilt and turn’ mechanism 44 is used. The ‘tilt and turn’ mechanism comprises a metal strip that slides within a corner track and thereby transfers the movement around the corner to facilitate the driving of the elongate rigid member 31. It will be appreciated that only the arrangement for a lower track with four blades 1 is shown in the figure. The same arrangement would also be used for the upper track, which is not shown in this representation.

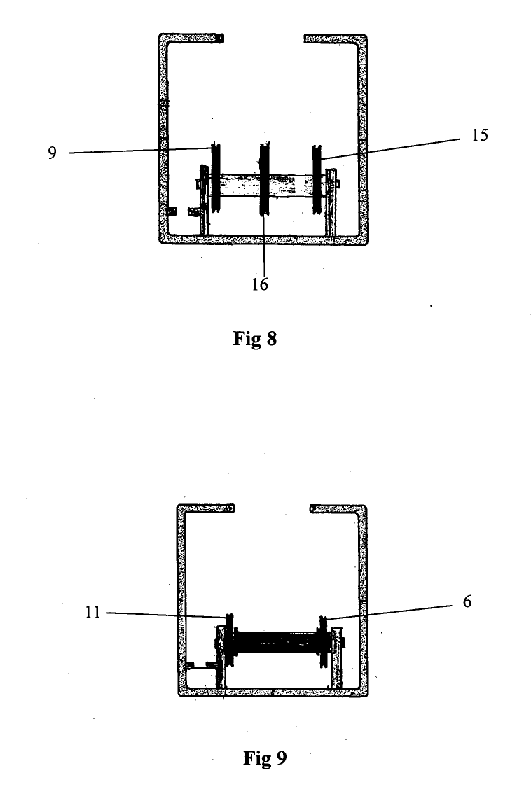

FIG. 8 shows a top plan view of the sliding side of the support structure. The arrangement of pulleys 9, 15 and 16 (from FIG. 1) within the support structure can be better appreciated from this figure. It will be appreciated that a similar diagram may also be used to represent the bottom plan view of the sliding side of the support structure. The control means for moving the blades are located on the sliding side of the support structure, said control means could take the form of a lever.

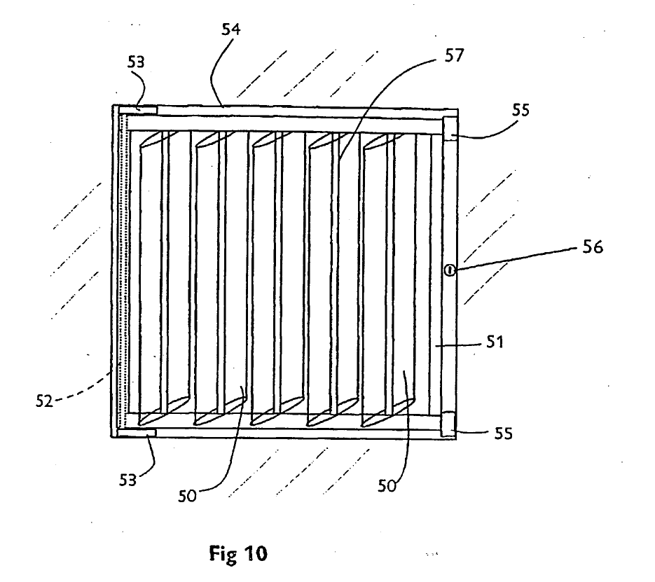

FIG. 9 shows a top plan view of the locking side of the support structure. The arrangement of pulleys 6 and 11 (from FIG. 1) within the support structure can be better appreciated from this figure. It will be appreciated that a similar diagram may also be used to represent the bottom plan view of the locking side of the support structure. The control means for the spindle locking means, as shown in FIG. 7, are located on the locking side of the support structure. As discussed above, the control means could be actuated by a handle. For additional security the handle could be removeable, thus preventing the unlocking of the spindle locking means in its absence.

1. A window security shutter comprising:
a shutter frame securable in a window opening;
a plurality of parallel rigid blades extending across the shutter frame,
each said blade having a hollow, pointed oval, cross section,
each said blade having a rigid reinforcing axial member having at each end thereof a spindle engaged in a respective opposing side of the shutter frame in such a manner as to permit rotation of the blades about the spindles;
a control mechanism for rotating the blades between a closed position, in which the blades lie substantially parallel to the window so as to form together a continuous shutter therefore, and an open position, in which the blades extend substantially normally to the window to permit light and air to pass there between.

2. A window security shutter according to claim 1, wherein the blades are formed into shape by extrusion.

3. A window security shutter according to claim 1, said hollow pointed oval cross section of said blades being filled with insulating material.

4. A window security shutter according to claim 1, wherein the rigid reinforcing members comprise steel bars.

5. A window security shutter according to claim 1, said shutter frame being hingedly securable by one edge to said window opening and configured with releaseable locking on an opposing edge for securing said frame within said window opening.

6. A window security shutter according to claim 1, at least one side of said blades having a reflective surface.

7. A window security shutter according to claim 1, said opposing sides of said shutter frame configured with respective tracks within which said spindles are engaged; said combined window blind and security shutter further comprising spindle locking means operable to constrain the spindles from lateral movement along the tracks while still permitting rotation thereof, the spindle locking means being releasable to allow lateral movement of the spindles.

8. A window security shutter according claim 7, wherein the spindles are joined together by flexible members, coupled at predetermined intervals to the spindles.

9. A window security shutter according to claim 8, wherein the spindle locking means comprises an elongate member, having receiving means positioned periodically along the length thereof, wherein the receiving means are engageable to the corresponding spindles of each blade, thereby constraining the spindles from lateral movement within the support structure.

10. A window security shutter according to claim 9, wherein the spindle locking means comprise a deadlock to secure the elongate member in its engaged position.

11. A window security shutter according to claim 1, wherein the control mechanism comprises a cord joining the corresponding edges of the respective said blades together so that pulling the cord in one direction rotates the blades in that direction and pulling the cord in the opposite direction reverses the rotation of the blades.

12. A window security shutter according to claim 1, wherein the blades are configured with means for receiving an aesthetic finishing strip.

13. A window security shutter according to claim 1, wherein a collection of finishing strips are arranged on the blades so as to display a message when the blades are in the closed position.

14. A window security shutter comprising:
a shutter frame hingedly securable by one edge to a window opening and configured with releaseable locking means on an opposing edge for securing said shutter frame within said window opening;
a plurality of parallel rigid blades extending across the shutter frame, said blades formed by extrusion into a hollow, pointed oval, cross section shape, each said blade having at each end thereof a spindle engaged in a respective opposing side of the shutter frame in such a manner as to permit rotation of the blades about the spindles;
a control mechanism for rotating the blades between a closed position in which the blades lie substantially parallel to the window so as to form together a continuous shutter therefore, and an open position in which the blades extend substantially normally to the window to permit light and air to pass there between, said control mechanism comprising a cord joining the corresponding edges of the blades together so that pulling the cord in one direction rotates the blades in that direction and pulling the cord in the opposite direction reverses the rotation of the blades.

15. A window security shutter according to claim 14, said hollow pointed oval cross section of said blades being filled with insulating material.

16. A window security shutter according to claim 15, at least one side of said blades having a reflective surface.

17. A window security shutter according to claim 14, said respective opposing sides of said shutter frame configured with respective tracks within which said spindles are engaged; said combined window blind and security shutter further comprising spindle locking means operable to constrain the spindles from lateral movement along the tracks while still permitting rotation thereof, the spindle locking means being releasable to allow lateral movement of the spindles.

18. A window security shutter comprising:
a shutter frame hingedly securable by one edge to a window opening and configured with releaseable locking means on an opposing edge for securing said shutter frame within said window opening;
tracks in two opposing said sides of said shutter frame;
a plurality of parallel rigid blades extending across the shutter frame, said blades formed by extrusion into a hollow, pointed oval, cross section shape, each said blade having at each end thereof a spindle engaged in a respective said track in such a manner as to permit rotation of the blades about the spindles;
spindle locking means operable to constrain the spindles from lateral movement along the tracks while still permitting rotation thereof, the spindle locking means being releasable to allow lateral movement of the spindles; and
control mechanism for rotating the blades between a closed position in which the blades lie substantially parallel to the window so as to form together a continuous shutter therefore, and an open position in which the blades extend substantially normally to the window to permit light and air to pass there between.

19. A window security shutter according to claim 18, said control mechanism comprising a cord joining the corresponding edges of the blades together so that pulling the cord in one direction rotates the blades in that direction and pulling the cord in the opposite direction reverses the rotation of the blades.

20. A window security shutter according to claim 18, said blades being reenforced with a strengthening material.
